(19) United States
(12) Patent Application Publication
(10) Pub. No.: US 2026/0073118 A1
(43) Pub. Date: Mar. 12, 2026

(54) TEXT ADJUSTMENT METHOD AND PRODUCTS THEREOF

(71) Applicants: Guangzhou Xiyin International Import and Export Co., Ltd., Guangdong (CN); Shenzhen Xiyin Information Technology Co., Ltd., Guangdong (CN); Nanjing Xiyin Ecommerce Co., Ltd., Jiangsu (CN)

(72) Inventor: HUILI QIAN, Guangdong (CN)

(21) Appl. No.: 19/172,812

(22) Filed: Apr. 8, 2025

(30) Foreign Application Priority Data
Sep. 11, 2024 (CN) 2024112733967

(51) Int. Cl. G06F 40/109

(52) U.S. Cl. CPC G06F 40/109

(57) ABSTRACT

A text adjustment method includes monitoring content change events for each text node, if a content change event is detected, obtaining actual font information of the updated text in a text node where the content change event occurred, and determining an actual text width of the updated text based on the actual font information, determining a font size variation based on the actual font information and user-input expected configuration information, determining a target scaling ratio for the updated text based on the actual font information, the actual text width, the font size variation, and the expected configuration information. Efficient and convenient adaptive scaling and fixing of text is enabled, computational performance consumption is reduced, text fixing accuracy is improved, and, thus, the efficiency of site expansion is enhanced.

### CROSS REFERENCE TO RELATED APPLICATIONS AND CLAIM OF PRIORITY

This application claims the benefit under 35 USC § 119 of Chinese Patent Application No. 2024112733967 filed on Sep. 11, 2024, in the Chinese Intellectual Property Office, the entire disclosure of which is incorporated herein by reference for all purposes.

### BACKGROUND

### 1. Technical Fields

This application generally relates to the technical field of data processing. More specifically, this application relates to a text adjustment method and products thereof.

### 2. Background Arts

During a process of expanding sites and launching them in overseas countries, each site expansion requires fixing a large number of text style disorders. However, personnel involved in each site expansion may use different fixing solutions, which cannot satisfy all online real and complex scenarios requiring adaptive text fixing or achieve a goal of rapid site expansion. Existing adaptive text fixing methods may involve boundary testing to obtain a final text scaling value. However, if this existing solution is used for adaptive fixing, fixing code needs to be additionally written for different online scenarios, resulting in high complexity, and moreover, a single line of text may require dozens of calculations to obtain the final text scaling value, which not only consumes significant computational performance but also increases the likelihood of calculation errors, which may lead to inconsistent performance across different sites, requiring continuous text adjustments during each site expansion, thereby decreasing efficiency.

In view of this, there is an urgent need for a text adjustment method that can efficiently and conveniently perform adaptive scaling and fixing of text, reduce computational performance consumption, improve text fixing accuracy, and thereby enhance the efficiency of site expansion.

### SUMMARY

To at least address one or more of the technical problems mentioned above, this application proposes a text adjustment method and products thereof in various aspects. The text adjustment method can efficiently and conveniently perform adaptive scaling and adjustment of text, reduce computational performance consumption, improve text fixing accuracy, and thereby enhance the efficiency of site expansion.

In a first aspect, this application provides a text adjustment method, including: monitoring content change events for each text node; if a content change event is detected, obtaining actual font information of the updated text in a text node where the content change event occurred, and determining an actual text width of the updated text based on the actual font information; determining a font size variation based on the actual font information and user-input expected configuration information; and determining a target scaling ratio for the updated text based on the actual font information, the actual text width, the font size variation, and the expected configuration information.

In one embodiment, the actual font information includes an actual font size, and the expected configuration information includes an expected text width; wherein the determining the font size variation based on the actual font information and the user-input expected configuration information includes: determining the font size variation based on the actual font size and the expected text width.

In one embodiment, the determining the target scaling ratio for the updated text based on the actual font information, the actual text width, the font size variation, and the expected configuration information includes: determining an estimated text width based on the actual font size and the font size variation; and determining the target scaling ratio based on the actual text width, the expected text width, the font size variation, and the estimated text width.

In one embodiment, the determining the target scaling ratio based on the actual text width, the expected text width, the font size variation, and the estimated text width includes: determining the target scaling ratio using a scaling ratio formula based on the actual text width, the expected text width, the font size variation, and the estimated text width; the scaling ratio formula being:

$$S = \frac{( {W}_{s} - {W}_{e} ) \times D}{{W}_{s} - {W}_{t}}$$

where S is the target scaling ratio, Ws is the actual text width, We is the expected text width, D is the font size variation, and Wt is the estimated text width.

In one embodiment, the monitoring content change events for each text node includes: creating an observer object for each text node; and inputting the observer object corresponding to each text node into a preset monitoring interface to monitor the content change events for each text node via the preset monitoring interface.

In one embodiment, the actual font information further includes an actual font type and an actual font weight; wherein the determining the actual text width of the updated text based on the actual font information includes: inputting the actual font size, the actual font type, and the actual font weight into a preset measurement interface to obtain the actual text width outputted from the preset measurement interface.

In one embodiment, before obtaining the actual font information of the updated text in the text node where the content change event occurred, the method further includes: monitoring a font loading time for the updated text using a timed execution function.

In one embodiment, the obtaining the actual font information of the updated text in the text node where the content change event occurred includes: if the font loading time is less than or equal to a preset duration, obtaining the actual font information of the updated text; and if the font loading time exceeds the preset duration, obtaining a system-native font corresponding to the updated text as the actual font information of the updated text.

In a second aspect, this application provides a device for text adjustment, characterized by including: a memory; and at least one processor configured to: monitor content change events for each text node; if a content change event is detected, obtain actual font information of the updated text in a text node where the content change event occurred, and determine an actual text width of the updated text based on the actual font information; determine a font size variation based on the actual font information and user-input expected configuration information; and determine a target scaling ratio for the updated text based on the actual font information, the actual text width, the font size variation, and the expected configuration information.

In a third aspect, this application provides a non-transitory machine-readable medium storing program code for text adjustment, wherein when the program code is executed by at least one processor, it guides the at least one processor to perform operations including: monitoring content change events for each text node; if a content change event is detected, obtaining actual font information of the updated text in a text node where the content change event occurred, and determining an actual text width of the updated text based on the actual font information; determining a font size variation based on the actual font information and user-input expected configuration information; and determining a target scaling ratio for the updated text based on the actual font information, the actual text width, the font size variation, and the expected configuration information.

The technical solutions provided by this application may have the following favorable effects:

According to the text adjustment method and products thereof provided by this application, content change events for each text node are monitored to track content updates in each text node. If a content change event is detected, actual font information of the updated text in a text node where the content change event occurred is obtained, and an actual text width of the updated text is determined based on the actual font information, such that a width occupied by the updated text can be learnt.

Further, this application determines a font size variation based on the actual font information and user-input expected configuration information, and then determines a target scaling ratio for the updated text based on the actual font information, the actual text width, the font size variation, and the expected configuration information. This allows adaptive adjustment of the updated text based on the target scaling ratio, while only a single calculation is required to determine the target scaling ratio, thereby reducing computational performance consumption.

In summary, this application enables efficient and convenient adaptive scaling and fixing of text, reduces computational performance consumption, improves text fixing accuracy, and thereby enhances the efficiency of site expansion.

### BRIEF DESCRIPTION OF THE DRAWINGS

By referring to the detailed description of the accompanying drawings, the above and other objectives, features, and advantages of the exemplary embodiments of this application will become more apparent. In the drawings, several embodiments of this application are shown in an illustrative rather than restrictive manner, and the same or corresponding reference numerals indicate the same or corresponding parts.

FIG. 1 shows an exemplary flowchart of a text adjustment method according to some embodiments of this application;

FIG. 2 shows an exemplary flowchart of a text adjustment method according to other embodiments of this application;

FIG. 3 shows an exemplary flowchart of a text adjustment method according to further embodiments of this application; and

FIG. 4 shows a block diagram of a hardware configuration of a device 400 for text adjustment that can implement the text adjustment method according to the embodiments of this application.

### DETAILED DESCRIPTION

The technical solutions in the embodiments of this application will be described clearly and completely below with reference to the accompanying drawings. It is apparent that the described embodiments are only a part instead of all of the embodiments of this application. For simplicity and clarity, reference signs may be repeated in the drawings to indicate corresponding or similar elements where appropriate. Additionally, many specific details are set forth in this application to provide a thorough understanding of the described embodiments. However, those skilled in the art will understand that the embodiments described herein may be practiced without these specific details. In other instances, well-known methods, procedures, and components have not been described in detail to avoid obscuring the described embodiments. Moreover, the description should not be construed as limiting the scope of the embodiments described herein. Based on the embodiments of this application, all other embodiments obtained by those skilled in the art without creative efforts shall fall within the scope of this application.

It should be understood that terms such as “first” or “second” that may exist in the claims, description, and drawings of this application are intended to distinguish between different objects and not to describe a specific order. The terms “comprising” and “including” used in the description and claims of this application indicate the presence of the described features, entities, steps, operations, elements, and/or components, but do not exclude the presence or addition of one or more other features, entities, steps, operations, elements, components, and/or sets thereof.

It should also be understood that the terms used herein are for the purpose of describing specific embodiments only and are not intended to limit the application. As used in the description and claims of this application, the singular forms “a,” “an,” and “the” are intended to include the plural forms unless the context clearly indicates otherwise. It should also be further understood that the term “and/or” as used herein refers to and encompasses any and all possible combinations of one or more of the associated listed items.

As used in the description and claims of this application, the term “if” may be interpreted contextually as “when,” “upon,” “in response to determining,” or “in response to detecting.” Similarly, the phrase “if it is determined” or “if [a described condition or event] is detected” may be interpreted contextually as meaning “upon determining,” “in response to determining,” “upon detecting [the described condition or event],” or “in response to detecting [the described condition or event].”

Existing adaptive text fixing methods may involve boundary testing to obtain a final text scaling value. However, if this existing solution is used for adaptive fixing, fixing code needs to be additionally written for different online scenarios, resulting in high complexity. Moreover, a single line of text may require dozens of calculations to obtain the final text scaling value, which not only consumes significant computational performance but also increases the likelihood of calculation errors. This may lead to inconsistent performance across different sites, requiring continuous text adjustments during each site expansion, thereby decreasing efficiency.

In view of this, there is an urgent need for a text adjustment method that can efficiently and conveniently perform adaptive scaling and fixing of text, reduce computational performance consumption, improve text adjustment accuracy, and thereby enhance the efficiency of site expansion.

The specific embodiments of this application will be described in detail below with reference to the accompanying drawings.

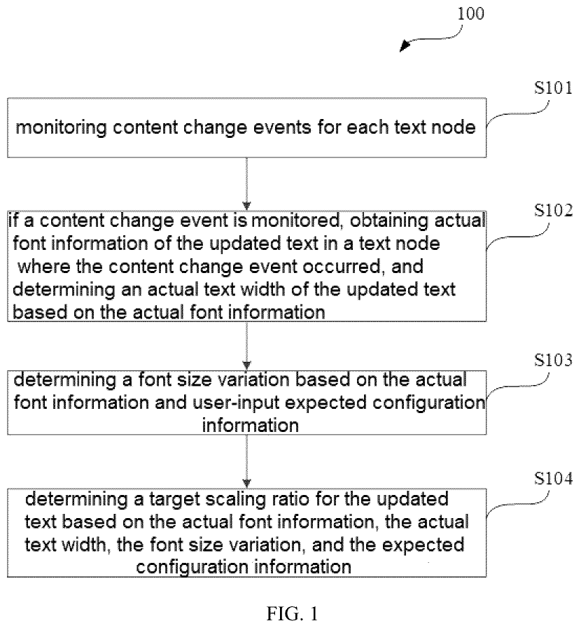

FIG. 1 shows an exemplary flowchart 100 of a text adjustment method according to some embodiments of this application. Referring to FIG. 1, the text adjustment method shown in the embodiments of this application may include the following steps:

In step S101, content change events for each text node are monitored. In the embodiments of this application, a text node as mentioned above refers to an area in a display interface used to present text. Additionally, the content change event refers to an event where the content within the text node is updated or changed. For example, if a display interface has an area for displaying a title, this area displaying the title can be considered as a text node. If initial content of this text node is empty and is later filled with title information after receiving feedback information via an interface, it can be determined a content change event has occurred in this text node.

In step S102, if a content change event is detected, actual font information of the updated text in a text node where the content change event occurred is obtained, and an actual text width of the updated text is determined based on the actual font information. For example, continuing with the example in step S101, text content of the title information is the updated text, and thus, actual font information of the updated text can be learnt. The actual font information may include, but is not limited to, an actual font size. It should be understood that in practical applications, specific content of the actual font information may be determined based on actual scenarios, and this application imposes no limitations in this regard.

Further, an actual text width of the updated text can be determined based on actual font information of the updated text. For instance, if the updated text consists of four characters, an actual text width of the updated text including these four characters can be determined based on the actual font information of the updated text, and thus, an actual width occupied by the updated text can be learnt.

In step S103, a font size variation is determined based on the actual font information and user-input expected configuration information. In the embodiments of this application, the expected configuration information may include, but is not limited to, an expected text width. It should be understood that based on the actual font size in the actual font information and the expected text width in the expected configuration information, it can be determined how much the actual font size needs to vary so as to enable the updated text to achieve the expected text width, so that the font size variation can be determined.

In step S104, a target scaling ratio for the updated text is determined based on the actual font information, the actual text width, the font size variation, and the expected configuration information. In the embodiments of this application, the updated text can be adaptively adjusted based on the determined target scaling ratio to ensure that the updated text as a whole conforms to the expected text width.

According to the embodiments of this application, content change events for each text node are monitored to track content updates in each text node. If a content change event is detected, actual font information of the updated text in a text node where the content change event occurred is obtained, and an actual text width of the updated text is determined based on the actual font information, so that a width occupied by the updated text can be learnt. Further, according to this application, a font size variation may be determined based on the actual font information and user-input expected configuration information, and a target scaling ratio for the updated text is determined based on the actual font information, the actual text width, the font size variation, and the expected configuration information. This allows adaptive adjustment of the updated text based on the target scaling ratio, while only a single calculation is required to determine the target scaling ratio, thereby reducing computational performance consumption. In summary, this application enables efficient and convenient adaptive scaling and fixing of text, reduces computational performance consumption, improves text fixing accuracy, and thereby enhances the efficiency of site expansion.

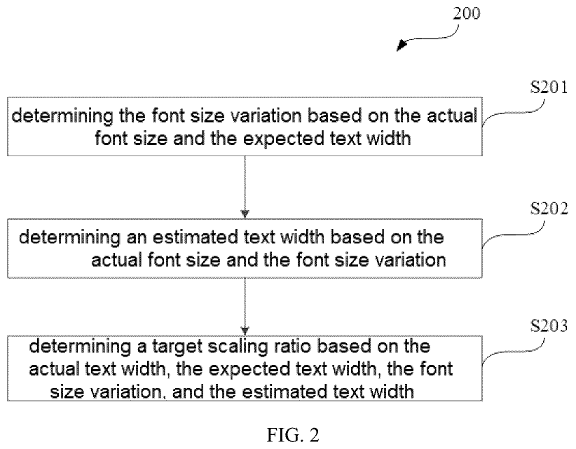

In some embodiments, the actual font information may include, but is not limited to, an actual font size, and the expected configuration information may include, but is not limited to, an expected text width. Thus, a font size variation can be determined using the actual font size and the expected text width, and then the target scaling ratio can be determined. The process of determining the target scaling ratio will be described in detail below with reference to FIG. 2. FIG. 2 shows an exemplary flowchart 200 of a text adjustment method according to other embodiments of this application. Referring to FIG. 2, the text adjustment method shown in the embodiments of this application may include the following steps:

In step S201, a font size variation is determined based on an actual font size and an expected text width. It should be understood that after the actual font size is increased or decreased by a certain variation, an adjusted font size can be obtained, and an adjusted text width can then be determined based on the adjusted font size. The method for determining the text width based on the font size may involve using the measureText function in Canvas. Canvas is an API interface provided by HTML5 for drawing, which allows developers to create complex graphics or even animations in browsers. The measureText function can be used to measure a width of text, i.e., a text width may be outputted based on an input text. It should be understood that there are various methods for determining the text width, and in practical applications, an appropriate method should be selected based on the actual application scenario. This application imposes no limitations in this regard.

In step S202, an estimated text width is determined based on the actual font size and the font size variation. In the embodiments of this application, since the font size variation is derived from the actual font size and the expected text width, it can be understood that the estimated text width determined based on an estimated font size obtained by increasing to or decreasing from the actual font size the font size variation may not exactly match the expected text width but will approach it. For example, it is assumed a current row of text is “Free Gifts,” with a font size of 24 px and a text width of 100 px in an English context. However, when this row of text is switched to a French context, it may become “Cadeaux gratuits,” and if the font size remains 24 px, the text width will be expanded to 180 px. It follows that the text width in the French context is wider than that in the English context, which will potentially cause text style disorders. Hence, at this time, after the font size is increased or decreased by the font size variation, such as decreasing the font size by 10 px, to make the current estimated font size as 14 px, the above-mentioned measureText function is used to determine an estimated text width, such as 120 px.

In step S203, a target scaling ratio is determined based on the actual text width, the expected text width, the font size variation, and the estimated text width. In the embodiments of this application, the target scaling ratio can be determined using a scaling ratio formula based on the actual text width, the expected text width, the font size variation, and the estimated text width, wherein the scaling ratio formula is as follows:

$$S = \frac{( {W}_{s} - {W}_{e} ) \times D}{{W}_{s} - {W}_{t}}$$

where S is a target scaling ratio, Ws is an actual text width, We is an expected text width, D is a font size variation, and Wt is an estimated text width. This formula allows the target scaling ratio to be calculated in a single step, avoiding determining the target scaling ratio by multiple times of tentative calculations by boundary testing (which means, for example, if the actual text size is 60 and the text width is 120 px, while the expected text width is 100 px, then the font size is tentatively decreased by 1 px, i.e., to 59 px; at this time, it is determined whether the text width is 100 px, and if it is not, continuing to tentatively decrease the font size by 1 px, and so on, until the text width reaches 100 px), thereby reducing times of calculations and reducing computational performance consumption.

It should be understood that after determining the target scaling ratio, text adjustment can be further performed using other parameters in the expected configuration information, wherein the expected configuration information may further include line-breaking parameters (multiLine). For example, continuing with the example in step S202, it is assumed the target scaling ratio is 0.5 (i.e., the font size in the French context needs to be scaled from 24 px to 12 px), if at this time the line-breaking parameter is a parameter corresponding to non-line-breaking, the 12 px font style is configured to the text area to complete the adjustment.

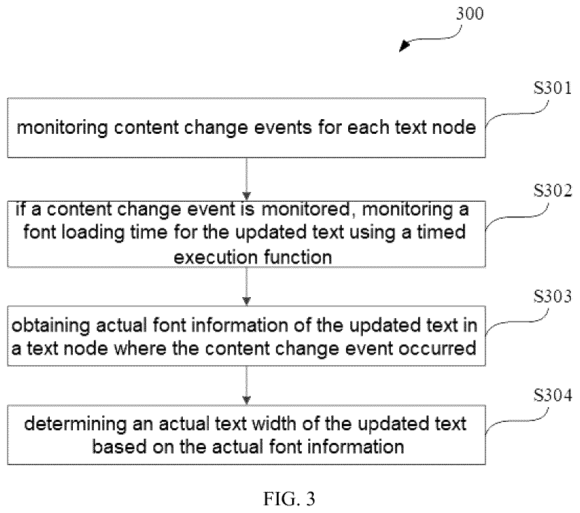

In some embodiments, the font loading time for the updated text can be limited to prevent delays in page rendering. FIG. 3 shows an exemplary flowchart 300 of a text adjustment method according to further embodiments of this application. Referring to FIG. 3, the text adjustment method according to embodiments of this application may include the following steps:

In step S301, content change events for each text node are monitored. In the embodiments of this application, an observer object can be created for each text node, and the observer object corresponding to each text node can be inputted into a preset monitoring interface to monitor the content change events for each text node via the preset monitoring interface. The preset monitoring interface may be JavaScript's MutationObserver. For example, if the initial content of a text node for a title is empty and is later filled with updated text after receiving feedback from a certain interface, this change of updated text can be monitored by the preset monitoring interface.

It should be understood that in practical applications, the method for monitoring content change events may be determined according to the actual scenario. This application imposes no limitations in this regard.

In step S302, if a content change event is detected, a font loading time of the updated text is monitored using a timed execution function. In the embodiments of this application, the timed execution function may be JavaScript's Promise function. The timed execution function is set to monitor the font loading time for the updated text, because calculating the text width depends on obtaining the font style, and the process of obtaining the font style can be considered as the font loading time. For example, the same number of characters in fonts like SimSun and Boldface may occupy different widths. Additionally, some interfaces may include custom fonts, which require more time to request loading thereof. Only after the fonts are loaded can the accurate text width be calculated based on the font style. Where slow loading of web fonts is caused by a poor network environment, the timing for calculating the text width will be delayed, thereby blocking subsequent rendering and refreshing of the page.

In step S303, actual font information of the updated text in a text node where a content change event occurred is obtained. In the embodiments of this application, if the font loading time is less than or equal to a preset duration, actual font information of the updated text is obtained; if the font loading time exceeds the preset duration, a system-native font corresponding to the updated text is obtained as actual font information of the updated text, without waiting for font loading for the updated text, wherein the preset duration may be 1 second. It should be understood that the preset duration can be set based on practical application condition in practical applications. This application imposes no limitations in this regard.

In step S304, an actual text width of the updated text is determined based on the actual font information. In the embodiments of this application, the actual font information may also include an actual font type (which is a set of glyphs that share the same appearance and typographic size, and can include styles such as SimSun, Regular Script and Boldface) and an actual font weight (which refers to thickness of the font). When an actual text width is calculated, the actual font size, actual font type, and actual font weight can be inputted into a preset measurement interface to obtain an actual text width outputted from the preset measurement interface. The preset measurement interface may be the measureText function in Canvas. This API interface provides high accuracy for determining the actual text width, is unaffected by document flow layout or other styles, and operates quickly without being constrained by the loading speed of text nodes. It only requires the text content and font style to begin calculations. It should be understood that there are various methods for determining the actual text width, and in practical applications, an appropriate method should be selected based on the practical application condition. This application imposes no limitations in this regard.

Corresponding to the aforementioned embodiments in which a method is implemented by functions, this application further provides a device for text adjustment and related embodiments.

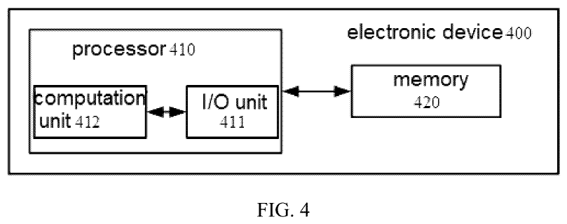

FIG. 4 shows a block diagram of a hardware configuration of a device 400 for text adjustment that can implement the text adjustment method according to the embodiments of this application. As shown in FIG. 4, the device 400 for text adjustment may include a processor 410 and a memory 420. In FIG. 4, only components relevant to this embodiment are shown in the device 400 for text adjustment. Therefore, it will be apparent to those skilled in the art that the device 400 for text adjustment may also include other common components not shown in FIG. 4, such as fixed-point arithmetic units.

The device 400 for text adjustment may correspond to computing devices with various processing functions, such as functions of generating neural networks, training or learning neural networks, quantizing floating-point neural networks into fixed-point neural networks, or retraining neural networks. For example, the device 400 for text adjustment may be implemented as various types of devices, such as personal computers (PCs), server devices, mobile devices, etc.

The processor 410 controls all functions of the device 400 for text adjustment. For example, the processor 410 executes programs stored in the memory 420 of the device 400 for text adjustment to control all its functions. The processor 410 may be implemented by a central processing unit (CPU), a graphics processing unit (GPU), an application processor (AP), an artificial intelligence processor chip (IPU) and the like provided in the device 400 for text adjustment. However, this application is not limited to these implementations.

In some embodiments, the processor 410 may include an input/output (I/O) unit 411 and a computation unit 412. The I/O unit 411 may be used to receive various data, such as actual font information. For example, the computation unit 412 may be used to determine an actual text width of the updated text based on the actual font information received via the I/O unit 411; then determine a font size variation based on the actual font information and user-input expected configuration information; and finally determine a target scaling ratio for the updated text based on the actual font information, the actual text width, the font size variation, and the expected configuration information. This target scaling ratio may be outputted via the I/O unit 411. The output data may be provided to the memory 420 for read and use by other devices (not shown), or directly provided to other devices.

The memory 420 is hardware used to store various data processed by the device 400 for text adjustment. For example, the memory 420 may store processed data and data to be processed in the device 400 for text adjustment. The memory 420 may store datasets involved in the text adjustment method processed or to be processed by processor 410, such as actual font information. Additionally, the memory 420 may store applications, drivers and the like to be driven by the device 400 for text adjustment. For example, the memory 420 may store various programs related to the text adjustment method to be executed by the processor 410. The memory 420 may be DRAM, but this application is not limited to this. The memory 420 may include at least one of a volatile memory or a non-volatile memory. The non-volatile memory may include a read-only memory (ROM), a programmable ROM (PROM), an electrically programmable ROM (EPROM), an electrically erasable programmable ROM (EEPROM), a flash memory, a phase-change RAM (PRAM), a magnetic RAM (MRAM), a resistive RAM (RRAM), a ferroelectric RAM (FRAM), etc. The volatile memory may include a dynamic RAM (DRAM), a static RAM (SRAM), a synchronous DRAM (SDRAM), a PRAM, an MRAM, an RRAM, a ferroelectric RAM (FeRAM), etc. In an embodiments, the memory 420 may include at least one of a hard disk drive (HDD), a solid-state drive (SSD), a compact flash (CF), a secure digital (SD) card, a micro-SD card, a mini-SD card, an extreme digital (xD) card, caches, or memory sticks.

In summary, the specific functions implemented by the memory 420 and processor 410 of the device 400 for text adjustment provided in this embodiment can be explained in conjunction with the foregoing embodiments of this application and achieve the technical effects of the foregoing embodiments, which will not be repeated here.

In this embodiment, the processor 410 may be implemented in any suitable manner. For example, the processor 410 may take the form of microprocessors or processors, as well as a computer-readable media storing computer-readable program code (e.g., software or firmware) executable by the (micro)processor, logic gates, switches, Application-Specific Integrated Circuits (ASICs), programmable logic controllers and embedded microcontrollers.

It should also be understood that any module, unit, component, server, computer, terminal, or device executing instructions described herein may include or otherwise access computer-readable media, such as storage media, computer storage media, or data storage devices (removable and/or non-removable), such as magnetic disks, optical disks, or tapes. The computer storage media may include volatile and non-volatile, removable and non-removable media implemented in any method or technology for storing information, such as computer-readable instructions, data structures, program modules, or other data.

The foregoing content can be better understood based on the following clauses:

Clause A1: A text adjustment method, characterized by including: monitoring content change events for each text node; if a content change event is detected, obtaining actual font information of the updated text in a text node where the content change event occurred, and determining an actual text width of the updated text based on the actual font information; determining a font size variation based on the actual font information and user-input expected configuration information; and determining a target scaling ratio for the updated text based on the actual font information, the actual text width, the font size variation, and the expected configuration information.

Clause A2: The text adjustment method according to Clause A1, wherein the actual font information includes an actual font size, and the expected configuration information includes an expected text width; wherein the determining the font size variation based on the actual font information and the user-input expected configuration information includes: determining the font size variation based on the actual font size and the expected text width.

Clause A3: The text adjustment method according to Clause A2, wherein the determining the target scaling ratio for the updated text based on the actual font information, the actual text width, the font size variation, and the expected configuration information includes: determining an estimated text width based on the actual font size and the font size variation; and determining the target scaling ratio based on the actual text width, the expected text width, the font size variation, and the estimated text width.

Clause A4: The text adjustment method according to Clause A3, wherein the determining the target scaling ratio based on the actual text width, the expected text width, the font size variation, and the estimated text width includes: determining the target scaling ratio using a scaling ratio formula based on the actual text width, the expected text width, the font size variation, and the estimated text width; the scaling ratio formula being:

$$S = \frac{( {W}_{s} - {W}_{e} ) \times D}{{W}_{s} - {W}_{t}}$$

where S is the target scaling ratio, Ws is the actual text width, We is the expected text width, D is the font size variation, and Wt is the estimated text width.

Clause A5: The text adjustment method according to Clause A1, wherein the monitoring content change events for each text node includes: creating an observer object for each text node; and inputting the observer object corresponding to each text node into a preset monitoring interface to monitor the content change events for each text node via the preset monitoring interface.

Clause A6: The text adjustment method according to Clause A2, wherein the actual font information further includes an actual font type and an actual font weight; wherein the determining the actual text width of the updated text based on the actual font information includes: inputting the actual font size, the actual font type, and the actual font weight into a preset measurement interface to obtain the actual text width outputted from the preset measurement interface.

Clause A7: The text adjustment method according to Clause A1, wherein before obtaining the actual font information of the updated text in the text node where the content change event occurred, the method further includes: monitoring a font loading time for the updated text using a timed execution function.

Clause A8: The text adjustment method according to Clause A7, wherein the obtaining the actual font information of the updated text in the text node where the content change event occurred includes: if the font loading time is less than or equal to a preset duration, obtaining the actual font information of the updated text; and if the font loading time exceeds the preset duration, obtaining a system-native font corresponding to the updated text as the actual font information of the updated text.

Clause A9: A device for text adjustment, characterized by including: a memory; and at least one processor configured to: monitor content change events for each text node; if a content change event is detected, obtain actual font information of the updated text in a text node where the content change event occurred, and determine an actual text width of the updated text based on the actual font information; determine a font size variation based on the actual font information and user-input expected configuration information; and determine a target scaling ratio for the updated text based on the actual font information, the actual text width, the font size variation, and the expected configuration information.

Clause A10: A non-transitory machine-readable medium storing program code for text adjustment, wherein when the program code is executed by at least one processor, it guides the at least one processor to perform operations including: monitoring content change events for each text node; if a content change event is detected, obtaining actual font information of the updated text in a text node where the content change event occurred, and determining an actual text width of the updated text based on the actual font information; determining a font size variation based on the actual font information and user-input expected configuration information; and determining a target scaling ratio for the updated text based on the actual font information, the actual text width, the font size variation, and the expected configuration information.

Although several embodiments of this application have been shown and described here, it will be apparent to those skilled in the art that such embodiments are provided by way of example only. Numerous variations, changes, and substitutions will occur to those skilled in the art without departing from the spirits and scope of this application. It should be understood that various alternatives to the embodiments of this application described herein may be employed in practicing this application. The appended claims are intended to define the scope of this application and thus cover equivalents or alternatives within the scope of these claims.

What is claimed is:

1. A text adjustment method comprising:
monitoring content change events for each text node;
if a content change event is monitored, obtaining actual font information of the updated text in a text node where the content change event occurred, and determining an actual text width of the updated text based on the actual font information;
determining a font size variation based on the actual font information and user-input expected configuration information; and
determining a target scaling ratio for the updated text based on the actual font information, the actual text width, the font size variation, and the expected configuration information.

2. The text adjustment method according to claim 1, characterized by that the actual font information includes an actual font size, and the expected configuration information includes an expected text width; wherein the determining the font size variation based on the actual font information and the user-input expected configuration information comprises:
determining the font size variation based on the actual font size and the expected text width.

3. The text adjustment method according to claim 2, characterized by that the determining the target scaling ratio for the updated text based on the actual font information, the actual text width, the font size variation, and the expected configuration information comprises:
determining an estimated text width based on the actual font size and the font size variation; and
determining the target scaling ratio based on the actual text width, the expected text width, the font size variation, and the estimated text width.

4. The text adjustment method according to claim 3, characterized by that the determining the target scaling ratio based on the actual text width, the expected text width, the font size variation, and the estimated text width comprises:
determining the target scaling ratio using a scaling ratio formula based on the actual text width, the expected text width, the font size variation, and the estimated text width;
the scaling ratio formula being:
$$S = \frac{( {W}_{s} - {W}_{e} ) \times D}{{W}_{s} - {W}_{t}}$$
where S is the target scaling ratio, Wₛ is the actual text width, Wₑ is the expected text width, D is the font size variation, and Wₜ is the estimated text width.

5. The text adjustment method according to claim 1, characterized by that the monitoring content change events for each text node comprises:
creating an observer object for each text node; and
inputting the observer object corresponding to each text node into a preset monitoring interface to monitor the content change events for each text node through the preset monitoring interface.

6. The text adjustment method according to claim 2, characterized by that the actual font information further includes an actual font type and an actual font weight; wherein the determining the actual text width of the updated text based on the actual font information comprises:
inputting the actual font size, the actual font type, and the actual font weight into a preset measurement interface to obtain the actual text width outputted from the preset measurement interface.

7. The text adjustment method according to claim 1, characterized by that before obtaining the actual font information of the updated text in the text node where the content change event occurred, the method further comprises:
monitoring a font loading time for the updated text using a timed execution function.

8. The text adjustment method according to claim 7, characterized by that the obtaining the actual font information of the updated text in the text node where the content change event occurred comprises:
if the font loading time is less than or equal to a preset duration, obtaining the actual font information of the updated text; and
if the font loading time exceeds the preset duration, obtaining a system-native font corresponding to the updated text as the actual font information of the updated text.

9. A device for text adjustment, comprising:
a memory; and
at least one processor configured to:
monitor content change events for each text node;
if a content change event is monitored, obtain actual font information of the updated text in a text node where the content change event occurred, and determine an actual text width of the updated text based on the actual font information;
determine a font size variation based on the actual font information and user-input expected configuration information; and
determine a target scaling ratio for the updated text based on the actual font information, the actual text width, the font size variation, and the expected configuration information.

10. A non-transitory machine-readable medium storing program code for text adjustment, wherein when the program code is executed by at least one processor, it guides the at least one processor to perform operations comprising:
monitoring content change events for each text node;
if a content change event is detected, obtaining actual font information of the updated text in a text node where the content change event occurred, and determining an actual text width of the updated text based on the actual font information;
determining a font size variation based on the actual font information and user-input expected configuration information; and
determining a target scaling ratio for the updated text based on the actual font information, the actual text width, the font size variation, and the expected configuration information.
